(19) United States
(12) Patent Application Publication
(10) Pub. No.: US 2010/0096551 A1
(43) Pub. Date: Apr. 22, 2010

(54) SPECTROSCOPY MEASUREMENTS

(75) Inventors: Wouter Harry Jacinth Rensen, Eindhoven (NL); Levinus Pieter Bakker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/521,174

(22) PCT Filed: Dec. 20, 2007
(86) PCT No.: PCT/IB07/55244

§ 371 Date: Jun. 25, 2009

(30) Foreign Application Priority Data
Dec. 28, 2006 (EP) 06301300.7

(51) Int. Cl. G01J 5/02; G01N 21/55

(52) U.S. Cl. 250/339.07; 356/445

(57) ABSTRACT

The invention relates to a device and method for the measurement of the concentration of at least one substance in a turbid medium. The device comprises at least one radiation source (12) adapted to illuminate the turbid medium (17) on at least one irradiation area. The device further comprises at least one detector adapted to detect backscattered light from the turbid medium from at least one detection area and to generate detection signals representative of the backscattered light. The device is arranged to generate detection signals with respect to at least two different irradiation-detection distances. The irradiation-detection distances are defined as the respective distances between the irradiation areas and the detection areas. The device also comprises at least one spatial light modulator (2), comprising 17 at least two electrode plates (5, 8) enclosing a liquid (7), the electrode plates supporting a plurality of electrodes (6, 10) arranged to define, with the liquid (7), light transmission patterns depending on the electrical field between the electrodes (6, 10), the irradiation areas and/or the detection areas being defined by said light transmission patterns.

### FIELD OF THE INVENTION

The invention relates to spectroscopy measurements of the concentration of a substance in a scattering medium. In particular, it relates to a device and method for non-invasively monitoring the concentration of glucose in human blood.

### BACKGROUND OF THE INVENTION

Spectroscopy may be used to measure the concentration of a substance in the skin of a person. A light beam is sent on the skin and the light that has interacted with the medium (either backscattered or transmitted) is detected, so as to measure the reflectance of the probed skin volume. An absorption spectrum is deduced from the reflectance and the concentration of the target substance can be calculated from the absorption spectrum by means of a mathematical model, making use of known spectral characteristics of the substances contained within the medium. Spectroscopy on skin permits to estimate the person's blood concentration of an analyte, in vivo and non-invasively.

The basic idea of quantitative spectroscopy is to use the Lambert-Beer's law in order to deduce, from the measured intensity of light, the absorption coefficient of the probed medium and, therefrom, the concentration of the target substance. However, in transmission or diffuse reflection spectroscopy on a turbid medium such as human skin, the simple relation of the Lambert-Beer's law is not valid. A linear regression analysis on a spectrum of a turbid medium is prone to errors, thus leading to an effective reduction in measurement accuracy. Indeed, the attenuation coefficient of the Lambert-Beer's law for a turbid medium is dependent on both the absorption and the scattering coefficients. Furthermore, the pathlength of light in the probed volume is not defined; photons reaching the detector will have traveled different paths with different lengths.

In response to those problems, international patent application filed by the Applicant on Nov. 17, 2006, under no IB 2006/054311, describes an apparatus for the non-invasive measurement of a concentration of at least one analyte in a turbid medium with an effective attenuation coefficient μeff(λ) in particular blood, comprising:
at least one radiation source adapted to generate a spectrum of electromagnetic radiation and to transmit said spectrum of electromagnetic radiation to the turbid medium,
at least one detector adapted to detect a spectrum of reflected radiation from the turbid medium and to generate detection signals representative of the detected radiation, wherein irradiation areas of said radiation source and detection areas of said detector on the turbid medium are arranged for to generate detection signals with respect to at least two different source-detector distances ρ1,2, wherein said source-detector distances are defined as the respective distances between the irradiation areas and the detection areas, said source-detector distances being chosen such that ρ1,2 >>1/μeff, and
data processing means adapted to determine from the detection signals a first quantity representative of a relative change in reflection with respect to the source-detector distance and deriving from said first quantity a second quantity representative of the effective attenuation coefficient WI', and to determine said concentration from said second quantity.

More precisely, in accordance with the invention of patent application no IB 2006/054311, the measurement scheme for determining the concentration of an analyte is:

1. take the reflection spectrum, R, at two source-detector distances which are large enough, i.e. ρ1,2 >>1/μeff;

2. compute the derivative of ln(R) with respect to p and square the result, thus obtaining said first quantity representative of a relative change in reflection with respect to the source-detector distance. This is equivalent to saying that the first quantity is determined by computing the derivative of ln(R), R being the intensity reflection coefficient, with respect to the source-detector distance and squaring the result of said computation;

3. according to the following equation:

$$Sr ≡ {[ \frac{d ln ( R )}{d ρ} ]}^{2} \approx 3 {μ}_{a} {μ}_{s}^{′}$$

(where μₐ is the total absorption coefficient and μₛ′ is the reduced scattering coefficient of skin), derive from said first quantity a second quantity, Sr, representative of the effective attenuation coefficient, μeff, and determine said concentration from said second quantity.

Computing a relative change in reflection with respect to the source-detector distance has the additional advantage that no absolute calibration of the employed equipment is necessary, i.e. day-to-day variation of source strength or detector efficiency is not important. The equipment should only be able to produce repeatable results during the measurement of the two required spectra at respective source-detector distances, i.e. on a rather short time interval.

The method of patent application no IB 2006/054311 will not be detailed further and reference will be made to the description of this document if further details are required.

For the material implementation of the method of patent application no IB 2006/054311, the turbid medium can for instance be irradiated in essentially concentrical circular areas extending around a central detection area. In a corresponding embodiment of an apparatus of patent application no IB 2006/054311, the radiation source comprises at least two concentrical circular arrangements of a respective plurality of waveguide fibers essentially extending to the boundary of the turbid medium and arranged around a common central detection area on said boundary of the turbid medium, wherein the detector comprises at least one central waveguide fiber essentially extending to the boundary of the turbid medium and in operative connection with the data processing means.

### SUMMARY OF THE INVENTION

It is an object of the present invention to provide an alternative device for implementing a method where a turbid medium is analyzed with measurements at least two source-detector distances, especially for implementing a method of the type described in patent application no IB 2006/054311. In the foregoing, the “source-detector distance” will rather be designated as the “irradiation-detection distance”.

In accordance with the present invention there is provided a device for the measurement of the concentration of at least one substance in a turbid medium, comprising:
at least one radiation source adapted to illuminate the turbid medium on at least one irradiation area,
at least one detector adapted to detect backscattered light from the turbid medium from at least one detection area and to generate detection signals representative of the backscattered light,
the device being arranged to generate detection signals with respect to at least two different irradiation-detection distances, wherein said irradiation-detection distances are defined as the respective distances between the irradiation areas and the detection areas,
the device comprising at least one spatial light modulator, comprising at least two electrode plates enclosing a liquid, the electrode plates supporting a plurality of electrodes arranged to define, with the liquid, light transmission patterns depending on the electrical field between the electrodes, the irradiation areas and/or the detection areas being defined by said light transmission patterns.

A spatial light modulator is a very simple and adaptable device and does not involve any flexibility concern as to its positioning; many irradiation-detection distances can be contemplated, since the irradiation and/or detection areas are defined by the light transmission patterns of the modulator. Besides, a modulator has high and stable spectral transmission and has a flexible transmission geometry, that is to say, the light transmission patterns can easily be changed, just operating the electrodes. The transition between the different light transmission patterns can be obtained quickly. Furthermore, such modulators can be produced at low prices.

Thanks to the invention, it is possible to arrange the device in such a way that no fibers are involved in the transmission of light in at least one direction, to or from the turbid medium; as a consequence, no coupling concerns are involved in this direction and no risk exists of a loss of light.

According to an embodiment, the liquid and the electrodes are arranged to define opaque and transparent areas through the modulator, depending on the electrical field between the electrodes.

According to an embodiment, the device comprises a fixed central detection area and is arranged to define circular irradiation areas.

According to an embodiment, the liquid is a liquid crystal.

According to an embodiment, the liquid is an electrowetting liquid.

According to an embodiment, the electrode plates comprise a semiconductor.

According to an embodiment in that case, the modulator comprises light sensors and photodiodes arranged on a semiconductor plate.

According to an embodiment, the device is arranged to control the absorbance and reflection of the modulator on the light path between the turbid medium and the modulator.

According to an embodiment, the device comprises an electrophoretic liquid arranged to control the absorbance and reflection of the modulator.

In accordance with the present invention there is also provided a method for the measurement of the concentration of at least one substance in a turbid medium, comprising:
illuminating the turbid medium on at least one irradiation area,
detecting backscattered light from the turbid medium from at least one detection area and generating detection signals representative of the backscattered light,
the method comprising generating detection signals with respect to at least two different irradiation-detection distances, wherein said irradiation-detection distances are defined as the respective distances between the irradiation areas and the detection areas,
controlling at least one spatial light modulator, comprising at least two electrode plates, enclosing a liquid, the electrode plates supporting a plurality of electrodes arranged to define, with the liquid, light transmission patterns depending on the electrical field between the electrodes, in order to define the irradiation areas and/or the detection areas with said light transmission patterns.

In accordance with an embodiment, the method comprises controlling the absorbance and reflection of the modulator on the light path between the turbid medium and the detector, as a function of the irradiation-detection distance.

In accordance with the present invention there is also provided an application of the method presented above to the measurement of the concentration of glucose in human skin by near infrared (NIR) spectroscopy. One should however understand that the scope of the invention is not limited, neither to NIR spectroscopy nor to human skin.

These and other aspects of the invention will be more apparent from the following description with reference to the attached drawings.

### BRIEF DESCRIPTION OF THE DRAWINGS

FIG. 1 is a bottom view of a modulator according to a first embodiment of the device of the invention;

FIG. 2 is a side sectional view of the device of FIG. 1;

FIG. 3 is a bottom view of a modulator according to a particular embodiment of the device of the invention;

FIG. 4 is a bottom view of a modulator according to another particular embodiment of the device of the invention, with a first light transmission pattern, and

FIG. 5 is a bottom view of the modular of FIG. 4, with a second light transmission pattern.

### DETAILED DESCRIPTION OF THE EMBODIMENTS

The invention is based on defining light transmission patterns with a spatial light modulator, by applying a corresponding electrical field to the electrodes of this modulator. The plates, including the electrodes, should be transparent in the wavelength range of interest. According to an embodiment, the electrodes of the modulator can be operated so that certain parts of the modulator are transparent and other parts are opaque, in the wavelength range of interest, to define said light transmission patterns.

In the description, for commodity reasons, the device will be described with reference to inferior and superior positions. Those positions do not mean that the device cannot be orientated another way, but permit to describe the elements more easily. Those positions are the ones of the device of FIG. 2. The inferior part is the part that is on the side of the skin.

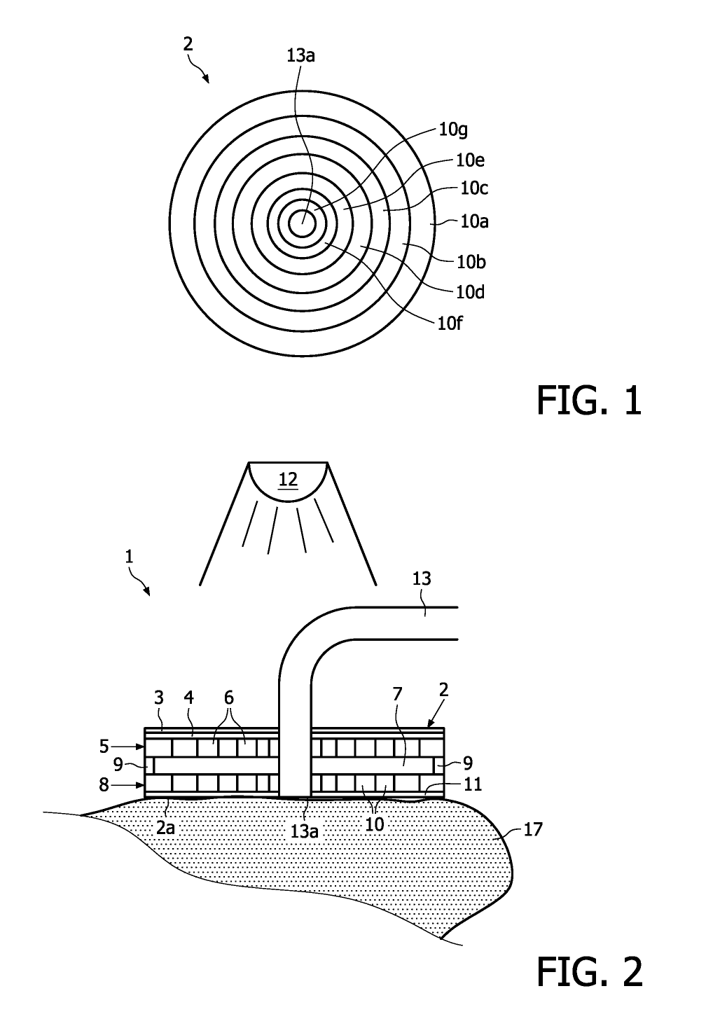

According to a first embodiment of the invention, and with reference to FIGS. 1 and 2, the device 1 comprises a spatial light modulator 2 which is of the type comprising a liquid crystal. The liquid crystal may be any liquid crystal suitable for this application. The modulator 2, which comprises stratified layers, comprises a first polarizer plate 3, a first electrode plate 5, supporting a first array of electrodes 6, a liquid crystal 7, sandwiched between the first electrode plate 5 and a second electrode plate 8, an outer ring 9 enclosing the periphery of the crystal liquid 7, the second electrode plate 8 supporting electrodes 10, and a second polarizer plate 11. The electrode plates 5, 8 are made of glass, the electrodes 6, 10 being made of ITO (Indium Tin Oxide), which is a classical configuration in liquid crystal devices. The layer referenced at 4 which can be seen on FIG. 1, is not related to the presently described embodiment but to the second embodiment described below. It should be considered as non existing in the description of the first embodiment, where the first polarizer plate 3 is in contact with the first electrode plate 5.

The device also comprises a light source 12, which is here a light source emitting radiations in the near-infrared (NIR) wavelengths, in order to implement NIR spectroscopy. Such a light is used because it penetrates more easily in the skin and is not immediately absorbed or heavily scattered. The light is emitted in the direction of the modulator 2, without guiding means. The illumination of the modulator 2 should preferably be stable, and even more preferably uniform. The light source 12 may be an incandescent lamp in combination with a reflector and/or a lens, a LED, a discharge lamp or any other suitable light source.

The electrodes 6, 10 are arranged in concentric rings, the electrodes 6 of the first plate 5 facing the electrodes of the second plate 8. In the described embodiment, as can be seen on FIG. 1, the second plate 8 comprises seven annular electrodes, referenced 10a, 10b, 10c, 10d, 10e, 10f, 10g.

The device also comprises a detector, not shown, which is connected to a detection fiber 13, adapted to collect light backscattered from the probed skin volume 17 and to direct it to the detector, which comprises means, not shown, adapted to generate detection signals representative of the backscattered light, as known in the art. The detection fiber 13 is inserted into a hole in the modulator 2. It is positioned in such a way that its distal end 13a (that is to say, its opening) is centrally positioned at the inferior boundary 2a of the modulator 2, that is to say, at the surface of the second polarizer 11 that is on the skin's side. In the embodiment described, this surface 2a is in contact with the probed skin volume 17. The opening 13a of the detection fiber 13 is therefore in close proximity to the probed skin volume 17 and collects more light.

The modulator 2 is provided on the light path, in order to define at least one of the two irradiation and detection areas; in the embodiment described, it defines the irradiation area. The light path extends from the light to the skin, through the skin and from the skin to the detector; in other words, the light path extends between the light source 12 and the detector and through the turbid medium (i.e. skin 17).

The modulator 2 functions as follows.

When the electrodes 6, 10 are not operated, that is to say, no electrical field is applied between them, the liquid crystal 7 is in its “default state”. In such a state, the modulator 2 is either opaque or transparent to NIR light, depending on the nature of the liquid crystal 7 and the polarizers 3, 11. Indeed, the incident light passes through the first polarizer 3, through the liquid crystal 7 and through the second polarizer 11; the liquid crystal may change or not the polarization of light; therefore, depending on the relative polarization directions of the polarizers 3, 11 and on the effect of the liquid crystal 7 on the light polarization when not electrical field is applied, light may either be transmitted or blocked in the “default state”. In the embodiment described, the light is blocked in this “default state”. When light is blocked through a certain region of the modulator 2, the region will be referred to as in an “opaque configuration”; this means that the assembly of the polarizers 3, 11 and the liquid crystal 7 is opaque, for the incident light, in the corresponding region. A region corresponds, on FIG. 1, to the shape of a particular electrode 10a-10g, on the height of the modulator 2; in other words, a region should be understood as the volume of the modulator 2 comprising facing electrodes and liquid therebetween.

If a couple of electrodes 6, 10, facing each other, is operated to create an electrical field between them, the molecules of the liquid crystal 7, comprised between those electrodes, orient differently, which modifies the direction of polarization of the transmitted light in the liquid crystal 7, here perpendicularly to the direction of the “default state”. The state, where the electrodes 6, 10 are operated, will be referred to as the “tension state” (since a tension is applied between the electrodes 6, 10). In the “tension state”, the light transmission of the modulator 2 is the contrary compared to the “default state”. Therefore, in the embodiment described, in the “tension state”, the light is transmitted. When light is transmitted through a certain region of the modulator 2, the region will be referred to as in a “transparent configuration”; this means that the assembly of the polarizers 3, 11 and the liquid crystal 7 is transparent for the incident light, in the corresponding region.

To put it in a nutshell, the liquid crystal 7 may either be in a “default state” (no electrical field) or in a “tension state”, depending on the electrical field between the electrodes. In each of these states, the corresponding region 10a-10g may either be in an “opaque configuration” or in a “transparent configuration”. In the embodiment described, to the “default state” corresponds the “opaque configuration”, and to the “tension state” corresponds the “transparent configuration”.

Therefore, some regions 10a-10g of the modulator 2 can be put in the transparent configuration while others are put in an opaque configuration, since the modulator 2 comprises a plurality of independent electrodes 10a-10g. Such combinations of opaque and transparent regions define light transmission patterns. Indeed, light is transmitted to the skin 17 through the transparent regions, but is reflected (and thus blocked) in the opaque regions.

In the foregoing, reference will only be made to the references 10a-10g of the electrodes of the second electrode plate 8 for the definition of the light transmission patterns. It should be understood that the electrodes 6 of the first electrode plate 5 are operated correspondingly.

In a particular embodiment, all the electrodes 6 of the first plate 5 are connected to the ground, the electrical field being determined by the electrodes 10 of the second plate 8. In another embodiment, it is the contrary. Whatever the embodiment is, it is understood that the command of the configuration (opaque or transparent) of the regions 10a-10g of the modulator 2 depends on the electrical field between the electrodes 6, 10 of the first and second electrode plates 5, 8 facing each other.

The irradiation-detection distance, that is to say, the distance between irradiation areas and the detection areas, can easily be chosen by deciding which of the regions 10a-10g should be put in the transparent configuration. For instance, if all the regions 10a-10g are put in the opaque configuration, except the second outer region 10b which is put in the transparent configuration, the incident light from the NIR light source 12 is transmitted through the transparent region 10b (and is reflected anywhere else on the modulator 2), penetrates into the probed skin volume 17, is backscattered and collected into the detection fiber 13, at its distal end 13a. Therefore, the irradiation-detection distance is, in that case, the distance between the distal end 13a of the detection fiber 13 and the transparent region 10b.

The operation of the device 1 will now be described in more details.

Firstly, and optionally, background measurements are performed. All the regions 10a-10g of the modulator 2 are put in an opaque configuration: light is not transmitted by any region of the modulator 2. Light is collected in the detection fiber 13; this permits to establish the presence of stray-light, offset of the detection and dark current of the detector 13.

Secondly, and optionally, “total transmission measurements” are performed, that is to say, measurements are performed with all the regions 10a-10g of the modulator in a transparent configuration. Such a step can be used to quickly establish the overall reflectance of the probed skin volume 17. The results can be used to evaluate the correct skin positioning and an expected integration time (the use of which is explained below).

Thirdly, a measurement is performed with an effective irradiation-detection distance. One or more regions 10a-10g of the modulator 2 are switched to the transparent configuration, the others being in opaque configuration, to target a specific irradiation-detection distance. The signal collected in the detection fiber 13 is processed and integrated in the detector (the other elements of which are not detailed herein) to establish the signal at the selected irradiation-detection distance. The integration time can be fixed, or be determined from the overall reflectance measurement mentioned above, or can be determined from the signal-to-noise ratio in the measurement. In the last case the measurement will last until a desired ratio signal on noise is achieved or a time limit is reached.

The third phase mentioned above is repeated for all the required irradiation-detection distances, in order to implement a method where measurements are performed at different irradiation-detection distances.

It may be noticed that light entering the modulator 2 is polarized by the first polarizer 3. This polarizer 3 can be suppressed if a polarized light source is used, such as a laser; it can also be replaced by a polarizer placed on the light path from the light source 12 to the modulator 2.

Light getting out of the modulator 2 is filtered by the second polarizer 11 (which may be called an analyzer, since it is placed at the output of the modulator 2). Instead, a polarizer could be placed on the light path from the modulator 2 to the skin 17, if the modulator 2 is not in direct contact with the probed skin volume 17 as in the above embodiment.

The electrodes geometry 6, 10, surrounding the detection fiber 13, is such that the light can be launched into the probed skin volume 17 in concentric rings. In the embodiment described, the width of the rings increases with increasing diameter. This permits to compensate for lower diffuse reflectance with increasing irradiation-detection distances.

The invention has been presented with electrodes in the form of concentric rings, but other geometries can be contemplated for the regions letting or not the incident light pass through. The advantage of the rings is that they are continuous geometries at equal distance of a central fiber.

In the embodiment described above, the modulator 2 serves to control the position and pattern of the irradiation area, while the position and pattern of the detection area is fixed (in the embodiment described, a central position, in the form of a disk (the fiber distal end 13a)). According to another embodiment, the modulator 2 serves to control the position and pattern of the detection area. For instance, in such a case, a fiber can be inserted in the center of the modulator and light be irradiated therein; the incident light is therefore launched according to a fixed position and pattern of the irradiation area. Besides, a detector, arranged to collect backscattered light coming from transparent regions of the modulator, can be placed in the proximity of the modulator. For instance, a lens can be provided and focus light from the detector area on a fiber or the entrance slit of a spectrograph. Alternatively, the light might be focused on a light sensor that is sufficiently large; such sensors are not wavelength specific and it might be necessary to sequentially irradiate the skin with different wavelengths. Alternatively again, a large photodetector can be provided directly on top of the modulator, and again it may be necessary to sequentially illuminate the skin with different wavelengths. Other configurations can of course be contemplated.

In any case, the element which is not controlled by the modulator can be fit within the modulator (as presented above) or outside the modulator.

It can also be contemplated to have both the irradiation area and the detection area controlled by a modulator.

Optionally, a polarization filter can be added to the light detection path with an orientation orthogonal to the polarization of the irradiation light. This results in a suppression of the light that has been reflected on the skin surface or that has been scattered only once or twice. As a result, the effective probing depth is increased.

A second embodiment of the invention will now be described.

For diffuse reflectance spectroscopy of a tissue to determine the glucose concentration, important absorption bands can be found at 1536 nm and 1688 nm. In order to compensate for the other tissue constituents, other wavelengths corresponding to absorption by these constituents need to be measured too. This expands the wavelength range to be measured. The typical wavelength range for diffuse reflectance spectroscopy on skin is approximately 1111-1835 nm.

According to the second embodiment of the invention, the electrode plates 5, 8 are made of a semiconductor, for instance silicon, the electrodes 6, 10 being made of doped silicon, obtained with standard semiconductor tools. The silicon therefore replaces the glass as a substrate. It is also possible to create a silicon layer on a glass plate, with silicon on insulator technology.

A first advantage of silicon is its high transmission, compared to ITO, in the wavelength range presented above.

A second advantage of silicon is that it acts as a filter for the visible wavelengths, which is not the case of glass. We may notice here that, concerning the first embodiment presented above with glass, a longpass filter may be used to block the visible light, the latter not being useful in the measurements made. Silicon can therefore replace such a longpass filter, or act as a second longpass filter.

A third advantage of silicon is that, since it is a semiconductor, it is possible to easily integrate temperature sensors and photodiodes in a sensor layer 4, which can be seen on FIG. 1. Such sensors and photodiodes are embodied in an integrated circuit on the sensor layer 4. Such a layer 4 may be added between the first polarizer 3 and the first electrode plate 5. It can also be realized integral with this first electrode plate 5, since both are based on the semiconductor. Therefore, a silicon plate could comprise, on one side, the sensor layer 4, on the other side, the electrodes layer 5.

Such sensors can be used to monitor the output power of the light source 12, which is beneficial for the accuracy of the measurements. The temperature sensors can also be used to measure the temperature of the silicon, since the transmission characteristics of silicon are temperature dependent and are known when the temperature is known; this also allows a more accurate measurement of the diffuse reflectance spectra, notably for the calibration of the instruments. The sensors may also be used to determine the temperature of the skin of the patient, if the modulator 2 is in contact with skin.

A third embodiment of the invention will now be described.

This embodiment is similar to the first one, except that the spatial light modulator does not comprise a liquid crystal cell but an electrowetting cell, in which a fluid can be switched between an absorbing state and a transmitting state, that is to say, between an opaque configuration and a transparent configuration. Electrowetting cells are known by the person skilled in the art and the material details of implementation of this embodiment will not be developed in details. The principle is similar to the one of the first embodiment: plates are provided with electrodes and surround a liquid therebetween, for instance, a mix of water and oil. When an electrical field is applied to certain electrodes, the position of water and oil changes within the corresponding volume of the cell, thus changing the optical transmission of the liquid. Therefore, light transmission patterns can be obtained, by applying an electrical field to certain electrodes and not the others. All the remarks which have been made for the liquid crystal embodiments (arrangement of the relative electrodes, irradiation area and/or detection area defined by the modulator, etc.) can be made for this embodiment, when applicable.

An advantage of this embodiment is that unpolarized incident light can be used and that the light, which is propagating through the cell, does not need to be collimated (it may be noticed that collimation is not necessary neither in the above embodiments).

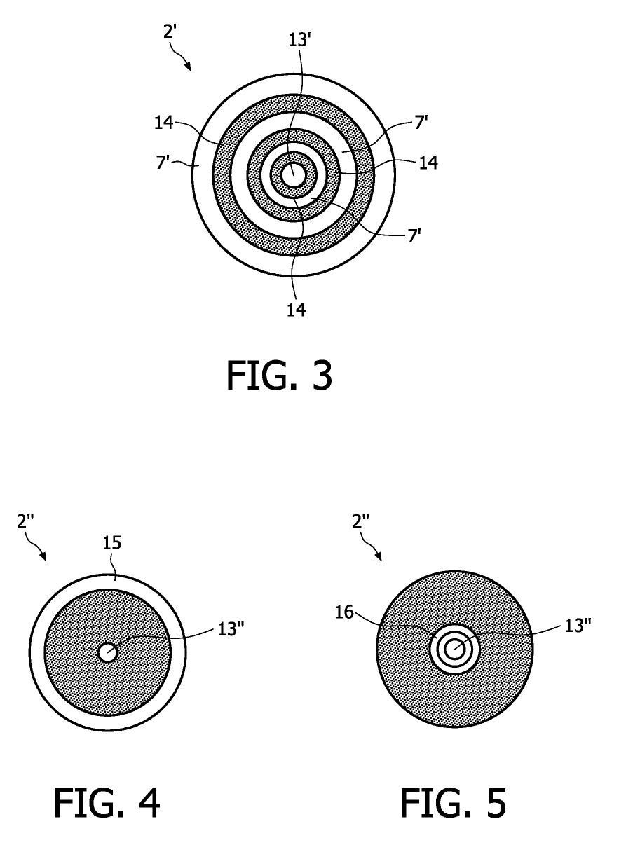

A fourth embodiment of the invention will now be described, with reference to FIG. 3.

This embodiment is based on the further use of an electrophoretic liquid to control the absorbance and reflection of the modulator, on the skin's side.

As can be seen on FIG. 3, the modulator 2′ comprises annular cells 7′ of liquid crystal, similar to the ones of the first embodiment above. The modulator 2′ further comprises annular cells 14 of an electrophoretic liquid. On FIG. 3, the liquid crystal cells 7′, represented in white, are alternated with the electrophoretic liquid cells 14, represented in black. A detection fiber 13′ is inserted in the center of the modulator 2′, as well as in the first embodiment. In this embodiment, the cells 7′, 14 are isolated from one another, the liquids 7, 14 therefore being enclosed between respective concentric cylinder walls.

An electrophoretic liquid is a liquid with colloidal particles in suspension therein. The suspensions may be moved by application of an electrical field. Depending on the applied electrical field, the electrophoretic liquid presents two states: an absorbing state and a reflecting state. In the embodiment described, the electrophoretic liquid comprises white and black particles; either white or black particles can be directed to the surface on the skin's side (in the embodiment described, in contact with the skin), by means of an electrical field, resulting in a detector with a controllable absorption and reflection. In the absorbing state, most of the backscattered light coming from the probed skin volume is absorbed by the electrophoretic liquid. In the reflecting state, most of the backscattered light coming from the probed skin volume is reflected by the electrophoretic liquid. In both states, the electrophoretic liquid is opaque for the incident light and therefore acts, for the incident light, as a liquid crystal which would be in the opaque configuration.

The function of the electrophoretic liquid cells 14 is therefore:
to block the incident light and
to control the absorption and reflection of the modulator 2′, on the skin's side, for the backscattered light.

This permits to correct the photon pathlength, by changing the (diffuse) reflectance of the modulator 2′ on the skin's side, as a function of the irradiation-detection distance.

If the irradiation-detection distance is large (that is to say, for instance, one of the most outer rings of the liquid crystal cells 7′ is in the transparent configuration while the others are in the opaque configuration), the electrophoretic cells 14 are controlled to be reflective for the backscattered light. As a consequence, the light which comes back after the first scatterings is not absorbed, but reflected by the electrophoretic cells surfaces and therefore comes back into the skin for further scattering. In such a reflecting state, the probed volume is not very deep, but the irradiation-detection distance is large.

If the irradiation-detection distance is small (that is to say, for instance, one of the most inner rings of the liquid crystal cells 7′ is in the transparent configuration while the others are in the opaque configuration), the electrophoretic cells 14 are controlled to be absorbing for the backscattered light. As a consequence, the light which comes back after the first scatterings is absorbed by the electrophoretic cells surfaces and does not come back into the skin for further scattering. In such an absorbing state, the probed volume is deeper than in the reflecting state, but the irradiation-detection distance is small. The probed volume is deeper because light traveling through the skin close to the skin surface has a high chance of reaching the skin surface and therefore to be absorbed and not reach the detector area; the light which reaches the detector area has therefore an average pathlength deeper than in the reflecting state.

It can be understood that the operation of the modulator 2′ of FIG. 3 is very similar to the operation of the modulator 2 of FIG. 2: the irradiation-detection distance is controlled with the liquid crystal cells 7′ (with the light transmission patterns of the electrodes), the eligible rings 7′ being only the ones in white in FIG. 3. The presence of the electrophoretic cells 14 does not change this operation since these cells are opaque for the incident light. Besides, the absorbance and reflection of the modulator 2′ on the side of skin is controlled with the electrophoretic cells 14, depending on the length of the irradiation-detection distance; this control is not binary but continuous, that is to say, the ratio between absorbance and reflection can be controlled.

A fifth embodiment of the invention will now be described, with reference to FIGS. 4 and 5.

This embodiment is very similar to the fourth embodiment, since the modulator 2″ is arranged to control the (diffuse) reflectance of the modulator's boundary for backscattered light.

In this embodiment, the modulator 2″ comprises an electrowetting liquid cell, as in the third embodiment described above, with a detection fiber 13″ in a central position. The electrowetting liquid is arranged so as to fulfill a double function:
a function of switch between opaque and transparent configurations for the incident light, which permits to create light transmission patterns for the incident light so as to control the irradiation-detection distance, as in the third embodiment, and
a function of control of the reflectance and absorbance of the surface of the modulator on the skin' side.

In that embodiment, it is assumed that when the modulator 2″ is in the transparent state, light coming back from the skin passes through the modulator 2″ and has a very small chance of reflecting back into the skin. The light is therefore effectively absorbed, that is to say, not reflected: the modulator 2″ is in an absorbing state on the skin's side. When the modulator 2″ is in the opaque state, it can be made reflective (i.e. by using a highly scattering electrowetting fluid (such as a suspension of scattering particles in either water or oil)): the modulator 2″ is therefore in a reflection state.

In the configuration of FIG. 4, the modulator 2″ comprises an outer ring 15 of electrowetting liquid in the transparent configuration, the rest of the liquid being in the opaque configuration. This configuration therefore implies a large irradiation-detection distance, while the opaque part of the liquid is in the reflection state for the backscattered light.

In the configuration of FIG. 5, the modulator 2″ comprises an inner ring 16 of electrowetting liquid in the transparent configuration, the rest of the liquid being in the opaque configuration. This configuration therefore implies a small irradiation-detection distance, while the opaque part of the liquid is in the absorbing state for the backscattered light.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1- Device for the measurement of the concentration of at least one substance in a turbid medium, comprising:
at least one radiation source (12) adapted to illuminate the turbid medium (17) on at least one irradiation area,
at least one detector adapted to detect backscattered light from the turbid medium from at least one detection area and to generate detection signals representative of the backscattered light,
the device being arranged to generate detection signals with respect to at least two different irradiation-detection distances, wherein said irradiation-detection distances are defined as the respective distances between the irradiation areas and the detection areas,
the device comprising at least one spatial light modulator (2, 2′, 2″), comprising at least two electrode plates (5, 8) enclosing a liquid (7, 7′, 7″), the electrode plates supporting a plurality of electrodes (6, 10) arranged to define, with the liquid (7, 7′, 7″), light transmission patterns depending on the electrical field between the electrodes (6, 10), the irradiation areas and/or the detection areas being defined by said light transmission patterns.

2- Device according to claim 1, wherein the liquid (7, 7′, 7″) and the electrodes (6, 10) are arranged to define opaque and transparent areas through the modulator (2, 2′, 2″), depending on the electrical field between the electrodes (6, 10).

3- Device according to claim 1, comprising a fixed central detection area (13a, 13′, 13″) and arranged to define circular irradiation areas (10a-10g).

4- Device according to claim 1, wherein the liquid is a liquid crystal (7).

5- Device according to claim 1, wherein the liquid is an electrowetting liquid.

6- Device according to claim 1, wherein the electrode plates (5, 8) comprise a semiconductor.

7- Device according to claim 6, wherein the modulator (2, 2′, 2″) comprises light sensors and photodiodes arranged on a semiconductor plate (4).

8- Device according to claim 1, arranged to control the absorbance and reflection of the modulator (2, 2′, 2″) on the light path between the turbid medium (17) and the modulator (2, 2′, 2″).

9- Device according to claim 8, which comprises an electrophoretic liquid (14) arranged to control the absorbance and reflection of the modulator (2, 2′, 2″).

10- Method for the measurement of the concentration of at least one substance in a turbid medium, comprising:
illuminating the turbid medium (17) on at least one irradiation area,
detecting backscattered light from the turbid medium from at least one detection area and generating detection signals representative of the backscattered light,
the method comprising generating detection signals with respect to at least two different irradiation-detection distances, wherein said irradiation-detection distances are defined as the respective distances between the irradiation areas and the detection areas,
controlling at least one spatial light modulator (2, 2′, 2″), comprising at least two electrode plates (5, 8), enclosing a liquid (7, 7′, 7″), the electrode plates supporting a plurality of electrodes (6, 10) arranged to define, with the liquid (7, 7′, 7″), light transmission patterns depending on the electrical field between the electrodes (6, 10), in order to define the irradiation areas and/or the detection areas with said light transmission patterns.

11- Method according to claim 10, comprising controlling the absorbance and reflection of the modulator (2, 2′, 2″) on the light path between the turbid medium (17) and the detector, as a function of the irradiation-detection distance.

12- Application of the method of claim 10 to the measurement of the concentration of glucose in human skin by near infrared spectroscopy.
